(19) United States
(12) Patent Application Publication
(10) Pub. No.: US 2017/0326020 A1
(43) Pub. Date: Nov. 16, 2017

(54) DEVICE FOR TREATING CONDITIONS ASSOCIATED WITH SEBUM PRODUCTION

(71) Applicant: L'OREAL, Paris (FR)

(72) Inventors: Elisa CABERLOTTO, Paris (FR); Leïla KANOUN-COPY, Clichy (FR); Thi Hong Lien PLANARD-LUONG, Chevilly Larue (FR); Gerald BREWER, Redmond, WA (US)

(73) Assignee: L'OREAL, Paris (FR)

(21) Appl. No.: 15/531,531

(22) PCT Filed: Nov. 27, 2015
(86) PCT No.: PCT/EP2015/077962

§ 371 Date: May 30, 2017

(30) Foreign Application Priority Data
Nov. 27, 2014 (EP) EP14306901.1

(51) Int. Cl. A61H 7/00

(52) U.S. Cl. CPC A61H 7/005; A61H 2205/021; A61H 2201/0107; A61H 2201/105; A61H 2201/1671

(57) ABSTRACT

A device for treating conditions associated with sebum production includes an end effector configured to apply a cycling mechanical strain, to an area of the scalp, of a character and for a duration sufficient to displace sebum.

### SUMMARY

In an aspect, the present disclosure is directed to, among other things, technologies and methodologies for treating conditions associated with sebum production.

In an aspect, the present disclosure is directed to, among other things, a cosmetic massaging device including an end effector. In an embodiment, the end effector includes a base part, and a treating member located centrally with respect to the base part. In an embodiment the treating member includes a plurality of massaging elements configured for massaging a scalp. In an embodiment, each of the massaging elements includes a stem provided at its distal end with an enlarged rounded head (15b). In an embodiment, the cosmetic massaging device includes a handpiece for oscillating angularly the at least one massaging element at a sonic frequency about an axis of rotation.

In an aspect, the present disclosure is directed to, among other things, a non-therapeutic cosmetic method for treating a condition associated with sebum production. In an embodiment, the method includes applying a cycling mechanical strain to an area of the scalp, the cycling mechanical strain of a character and for a duration sufficient to displace sebum. In an aspect, the present disclosure is directed to, among other things, a non-therapeutic cosmetic method for treating a condition associated with sebum production. In an embodiment, the method includes automatically delivering a cosmetic composition to an area of the scalp concurrently or sequentially to applying the cycling mechanical strain to an area of the scalp.

In an aspect, the present disclosure is directed to, among other things, a kit for treating the scalp and/or the hair.

Particularly the present invention is defined in the set of claims.

### BRIEF DESCRIPTION OF THE DRAWINGS

FIG. 1 is an isometric view of a handpiece configured for receiving an end effector according to an exemplary embodiment of the invention,

FIG. 2 is an isometric view of an end effector according to an exemplary embodiment of the invention, and

FIG. 3 is an axial cross section of the end effector of FIG. 2.

FIG. 4 shows a flow diagram of a non-therapeutic cosmetic method for treating a condition associated with sebum production according to one embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Sebaceous glands are microscopic exocrine glands in the skin that secrete an oily or waxy mixture made up of lipids, debris of fat-producing cells, etc., called sebum. Sebum lubricates and waterproofs the skin and hair of mammals, and acts as a barrier against foreign substances. But in some cases the sebaceous glands can overproduce sebum resulting in greasy or oily hair, clogged hair roots, dandruff, hair loss, and the like.

Washing the scalp and brushing hair are recurring acts that include removing dirt, dandruff, and excess sebum. Dandruff has been generally linked to sebum production. Until now, eliminating dandruff has been carried out by exfoliating or by combating yeasts of the Malassezia species that give rise to such dandruff. Hyper seborrhea can be treated with shampoos or lotions. Sebum appears to affect the penetration and activity of active compounds for hair re-growth. In an embodiment, washing hair and the scalp allows a better a penetration of the active compounds. Examples of tools for washing or massaging the scalp and the hair can be found in, for example, WO 2008/054089 A, U.S. Pat. No. 6,283,930 B, JP 2005-046190 A, JP 2006-034941 A. RU 2 186 514 C, WO 9²/₁8086 A, CN 201044658 Y, EP 0 446 495 A, JP 11070019 A, FR 2 729 075 A, and JP 2002-078761 A.

Examples of kits for treating cradle cap, or infantile eczema can be found in, for example, U.S. Pat. No. 6,043,202 B. Examples of scalp massaging device including a reservoir that is suitable for containing a liquid such as a shampoo or a lotion for stimulating hair growth can be found in U.S. Patent Pub. No. 2009/0182249. Examples of scalp massaging devices can be found in, for example, in EP 1 972 317 A, EP 1 964 537 A, and EP 2 080 500 A. Examples of methods and devices for treating the scalp comprising applying a composition and performing a massage of the scalp by means of spikes driven in an oscillating movement in contact with the scalp can be found in WO 2012/137167. Nevertheless, a need exists for a method effective against hair loss and/or for providing further benefits to the scalp and/or hair, such as eliminating dandruff. Accordingly, in an aspect, the present disclosure is directed to, among other things, technologies and methodologies for ameliorating one or more conditions associated with seburn production. In an embodiment, technologies and methodologies for prevention of hair loss and/or for treatment of scalp, include submitting an area of the scalp to superficial shear forces induced by at least one massaging element oscillating angularly in contact with the scalp at a sonic frequency about an axis of rotation substantially perpendicular to said area.

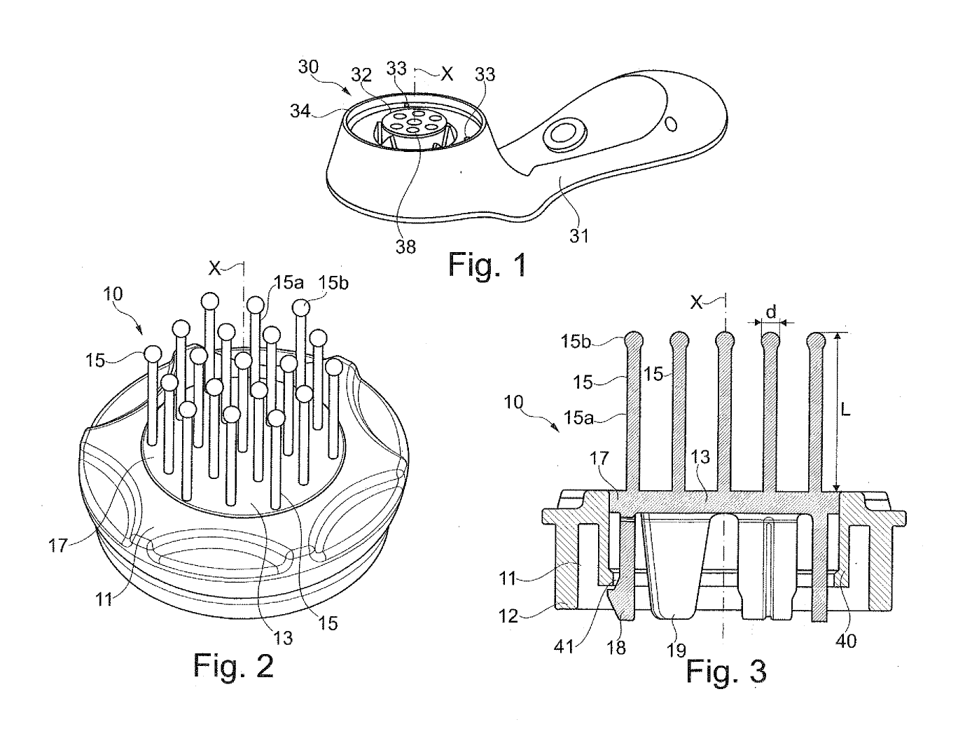

FIG. 1 shows a handpiece 30 in which one or more methodologies or technologies can be implemented such as, for example, treating a condition associated with sebum production. In an embodiment, the handpiece 30 is configured to receive an end effector component 10 as shown in FIGS. 2 and 3. For example, in an embodiment, the handpiece 30 comprises a casing 31 that houses an electric motor (not shown) and an electronic circuit for driving the motor at the appropriate frequency. In an embodiment, the motor mechanically couples to a hub 32 for driving the end effector component 10 in displacement, oscillation, rotation, vibration, and the like. In an embodiment, the hub 32 includes apertures 38 adapted for transmitting torque to the end effector component 10, as detailed hereunder.

In an embodiment, the handpiece 30 is configured to treat a condition associated with a sebaceous gland disorder. Non-limiting examples of sebaceous gland disorders include, acne, asteatosis, comedones, milia, seborrhea, steatoma, oily skin, and the like. In an embodiment, the handpiece 30 is configured to alleviate oily skin. In an embodiment, the handpiece 30 is configured to ameliorate a condition associated with sebum production.

In an embodiment, the end effector component 10 comprises as shown in FIG. 2 a base part 11 provided with fixation means adapted for mounting on the handpiece 30 such that the base part 11 removably attaches to the casing 31.

In an embodiment, the end effector component 10 includes a mounting skirt 12 provided with pin grooves (not shown) configured to allow the base part 11 to be positioned within the opening 34 of the handpiece 30 such that pins 33 of the handpiece 30 are at the entry point of the pin grooves. At the end of each pin groove, there is a notch that snap fasten on a corresponding pin 33.

In an embodiment, the end effector component 10 includes a treating member 13 located centrally with respect to the base part II.

In an embodiment, the end effector component 10 removably attaches to the handpiece 30. In an embodiment, the effector component 10 removably attaches to the handpiece 30 via at least one of a bayonet coupling structure, a friction fit coupling structure, a snap fit coupling structure, or a threaded coupling structure having one or more substructures adapted to coupled to a corresponding bayonet coupling structure, friction fit coupling structure, snap fit coupling structure, or threaded coupling structure on an assembly. In an embodiment, the effector component 10 is configure to removably attach to the handpiece 30 by a bayonet coupling, a friction fit coupling, a snap fit coupling, or a threaded coupling.

In an embodiment, the treating member 13 comprises a body 17 that is rotatably mounted within base part 11 about the axis X.

In an embodiment, a plurality of massaging elements 15 are mounted on the body 17. In an embodiment, each element 15 can take a variety of shapes, configurations, or geometries, including, but not limited to, cylindrical, conical, planar, parabolic, regular or irregular forms. In an embodiment, each element 15 consists of a stem 15 a provided at its distal end with an enlarged rounded head 15b. In an embodiment, head 15b can take a variety of shapes, configurations, or geometries, including, but not limited to, cylindrical, conical, planar, parabolic, regular or irregular forms. In an embodiment, head 15b is spherically shaped.

As shown on FIG. 3, in an embodiment, the body 17 comprises snap legs 18 that hold the body 17 axially within the base part 11 and drive legs 19 that are configured for engaging into corresponding apertures 38 of hub 32. Examples of snap legs 18 can be found in, for example, U.S. Pat. No. 7,386,906 (which is incorporated herein by reference). In an embodiment, each snap legs 18 includes one or more snap portion 41 configured for snap fastening on the lower end of a guiding skirt 40 extending coaxially to the mounting skirt 12 and of a smaller diameter. In an embodiment, the end effector component 10 includes three drive legs 19 and three snap legs 18, spaced at 120° intervals, and alternating in the circumferential direction. See e.g., U.S. Pat. No. 7,386,906 (which is incorporated herein by reference).

In an embodiment, a plurality of elements 15 forming part of a the end effector component 10, can take a variety of forms, configurations, and geometrical patterns including for example, but not limited to, a one-, two-, or three-dimensional arrays, one or more patterns comprising concentric geometrical shapes, one or more patterns comprising rectangles, squares, circles, triangles, polygons, one or more patterns comprising any regular or irregular shapes, or the like, or any combination thereof. In an embodiment, the number of elements 15 ranges from about 3 to about 30. In an embodiment, the number of elements 15 ranges from about 5 to about 25. In an embodiment, all elements 15 extend as shown substantially parallel to the axis X.

In an embodiment, the elements 15 have substantially the same length (L), as shown. In an embodiment, the length of each element 15 ranges from about 5 millimeters to about 50 millimeters. In an embodiment, the length of each element 15 ranges from about 8 millimeters to about 22 millimeters. In an embodiment, the length of each element 15 ranges from about 35 millimeters to about 45 millimeters. In an embodiment, the diameter d of an enlarged head 15b ranges from about 20 millimeters to about 50 millimeters. In an embodiment, the diameter d of an enlarged head 15b ranges from about 25 millimeters to about 40 millimeters.

In an embodiment, a cross-section of a stem 15 can take a variety of shapes, configurations, or geometries, including circular, polygonal, conical, regular or irregular forms, and the like.

In an embodiment, one or more of the elements 15 are formed, manufactured, fabricated, etc., from materials configure to flex during oscillation of the body 17. In an embodiment, each of elements 15, body 17, or base part 11, are made from the same or different materials.

In an embodiment, one or more of the elements 15 comprise one or more materials including polymers, plastics, nylons, polypropylene, natural fibers, wood, steel, and the like, or composites, mixtures, or laminates thereof. In an embodiment, one or more of the elements 15 comprise a head 15b comprise a material that is different from a material forming a stem 15a of elements 15. In an embodiment, one or more of the elements 15 include a head 15b formed from one or more epoxy materials. In an embodiment, one or more of the elements 15 include a head 15b comprising a hardness of about 83 Shore D. In an embodiment, one or more of the elements 15 include a head 15b comprising a Tensile Modulus ranging from about 100 (KPSI) to about 550 kpsi based on ASTM D638 (Standard Test Method for Tensile Properties). In an embodiment, one or more of the elements 15 include a head 15b comprising a Tensile Modulus ranging from about 230 kpsi (kilo-pound-force per square inch) to about 550 kpsi based on ASTM standard D638. In an embodiment, one or more of the elements 15 include a head 15b comprising a Tensile Modulus ranging of about 104 (kpsi) based on ASTM standard D638.

In an embodiment, the handpiece 30 and the end effector component 10, includes one or more structural elements manufactured from metals, ceramics, polymers, composite materials, or the like. In an embodiment, the handpiece 30 and the end effector component 10, includes one or more structural elements manufactured from polymeric materials. Non-limiting examples of polymeric materials included polyvinyl chloride, polyester, polyethylene, polypropylene, ethylene, or polyolefin, or homopolymers or copolymers thereof. In an embodiment, the handpiece 30 and the end effector component 10, includes one or more structural elements manufactured from polypropylene. In the embodiment shown, the elements 15 are molded in a single piece and in the same material as the body 17. In the embodiment, the elements are made of a different material than the body 17. In an embodiment, the base part 11 is molded in a relatively rigid plastics material such as polypropylene.

In the shown embodiment, a plurality of elements 15 is arranged in a configuration that is symmetrical relative to the axis X. In an embodiment, an element 15 may be located centrally on axis X and all other elements may be arranged along at least two sets of parallel rows, each set of row being perpendicular to the other set. In an embodiment, each set of row is composed in the example shown of 5 rows, with a number of elements per row that increases from 3 to 4 and then 5, and then decreases to 4 and then 3 again.

In an embodiment, the handpiece 30 may be of any kind appropriate for oscillating the active part of the end effector angularly at sonic frequencies about axis X. Examples of handpiece 30 can be found in, for example, in U.S. Pat. No. 7,386,906. In an embodiment, the casing 31 defines a handle for grasping by a user during operation.

In an embodiment, during operation, when the user switches the handpiece 30 ON, the hub 32 displaces, oscillates, rotates, vibrates, and the like, and drives the body 17 in displacement, oscillation, rotation, vibration, and the like. In an embodiment, during operation, body 17 oscillates about axis X at a sonic velocity and the user brings the tip of the elements 15 in contact with the scalp.

In an embodiment, during operation, the body 17 oscillates at a frequency ranging from about 60 Hz to about 200 Hz. In an embodiment, during operation, the body 17 oscillates at a frequency ranging from 60 Hz to about 90 Hz. In an embodiment, during operation, the body 17 oscillates at a frequency of about 70 Hz.

In an embodiment, during operation, the angular amplitude of the movement is ranges from about 3° to about 18° relative to a neutral position, thus amounting to a total amplitude between 6 and 36° about axis X. In an embodiment, during operation, the angular amplitude of the movement is ranges from about 3° to about 6° relative to a neutral position, thus amounting to a total amplitude between 6 and 12° about axis X.

In an embodiment, the displacement, oscillation, rotation, vibration, and the like, and combinations thereof, induced by the handpiece 30 may induce locally an applied mechanical strain on a region of the scalp in a direction perpendicular to the surface of the scalp in the range of about 100 microns to about 300 microns.

In an embodiment, the displacement, oscillation, rotation, vibration, and the like, and combinations thereof, applied by an end effector component 10 driven by the handpiece 30 results in applying the cycling mechanical strain to an area of the scalp. In an embodiment, applying the cycling mechanical strain to an area of the scalp includes applying an oscillating of a character and for a duration sufficient to induce a displacement of a region on the scalp in a direction perpendicular to the surface of the scalp in the range of of about 100 microns to about 300 microns.

In an embodiment, the vibrations induced by the handpiece 30 are pure rotational vibrations, i.e., the handpiece is not configured to vibrate the end effector component 10 in the direction of the axis X. Nevertheless, in an embodiment, the oscillating motion may induce locally a displacement of the scalp in a direction perpendicular to the surface of the scalp in the range of 100-300 microns.

In an embodiment, during operation a user secures the end effector component 10 to the handpiece 30 if the end effector 10 is not already present on the handpiece.

In an embodiment, when a user switches the handpiece 30 on, the hub 32 displacement, oscillation, rotation, vibration, and the like with a rotational movement and drives the body 17 in displacement, oscillation, rotation, vibration, and the like.

In an embodiment, the body 17 oscillates about axis X at a sonic displacement, oscillation, rotation, vibration or combinations thereof and the user brings the tip of the elements 15 in contact with the scalp, with axis X substantially perpendicular to the scalp. In an embodiment, the body 17 oscillates about axis X at a sonic oscillation and the user brings the tip of the elements 15 in contact with the scalp, with axis X substantially perpendicular to the scalp. In an embodiment, the body 17 oscillates about axis X at a sonic vibration and the user brings the tip of the elements 15 in contact with the scalp, with axis X substantially perpendicular to the scalp.

In an embodiment, the rounded enlarged ends of the elements 15 are vibrated in contact with the scalp and apply shear forces to the scalp.

In an embodiment, the massaging action performed with the device is followed by application of a cosmetic composition. In a variant, the composition is applied before the massaging takes place. In such a case, the composition may serve as a lubricant during the massaging action, reducing friction between the elements 15 and the skin.

In an embodiment, the device may also be configured to apply the composition and may contain a reservoir of composition feeding an applicator.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims. For example, in an embodiment, the end effector may be replaced by another one with no static base part, consisting of a single oscillating active part. In an embodiment, the end effector may comprise a base part that is assembled with the vibrator end effect or differently. In an embodiment, the attachment of the end effector component 10 to the handpiece 30 can be achieved by any other mechanical connexion. Preferably, the end effector component 10 is removably mounted on the handpiece, to allow the user to separate the end effector component 10 for cleaning for example and/or to use the handpiece 30 with different attachments.

In an embodiment, the handpiece may be configured so that the oscillation movement is not generated electronically but mechanically. In an embodiment, the number and arrangement of treating elements 15 may be varied without departing from the scope of this invention. For example, in an embodiment, the elements may be arranged along concentric circles. In an embodiment, the elements may not be all of the same height so that the envelope surface defined by their tips is concave towards the scalp and adapted to the curvature of the head. In an embodiment, the various components may be packaged with a composition to form a kit for treating the scalp.

The present invention is further directed to a cosmetic massaging device, comprising :

an end effector including

a base part, and

a treating member located centrally with respect to said base part, said treating member having a plurality of massaging elements configured for massaging a scalp, each of the massaging elements having a stem provided at its distal end with an enlarged rounded head; and

a handpiece for oscillating angularly the at least one massaging element at a sonic frequency about a rotation axis.

In an embodiment, a cosmetic composition is used together with the device includes a physiologically acceptable medium comprising for example at least one aqueous phase and/or at least one fatty phase. The composition may also contain at least one compound chosen from surfactants, fillers, gelifying agents, thickening agents, emulsifiers, film forming agents, polymers, preservatives, silicone elastomere, pigments, nacres, anti-free radical agents, insect repellent agents, bactericides, sequestrants, antioxidants, UV sunscreens, perfumes, humectants, emollients, pH regulators and mixtures thereof.

In an embodiment, a cosmetic composition includes at least one active ingredient selected from anti-seborrheic agents, anti-hair loss agents, anti-dandruff agents. In an embodiment, a cosmetic composition includes soothing or anti-irritant agents, exfoliating agents, moisturizing agents, or combinations or mixtures thereof.

In an embodiment, a cosmetic composition may contain a physiologically acceptable medium comprising at least one aqueous phase and/or at least one fatty phase. The cosmetic composition may also contain at least one compound chosen from surfactants, fillers, gelifying agents, thickening agents, emulsifiers, film forming agents, polymers, preservatives, silicone elastomere, pigments, nacres, anti-free radical agents, insect repellent agents, bactericides, sequestrants, antioxidants, UV sunscreens, perfumes, humectants, emollients, pH regulators and mixtures thereof.

The present invention is also directed to the use of the cosmetic device for performing the method according to the invention.

The present invention is also directed to a kit comprising a device according to the invention and a cosmetic composition for applying on the scalp, preferably contained in a same package.

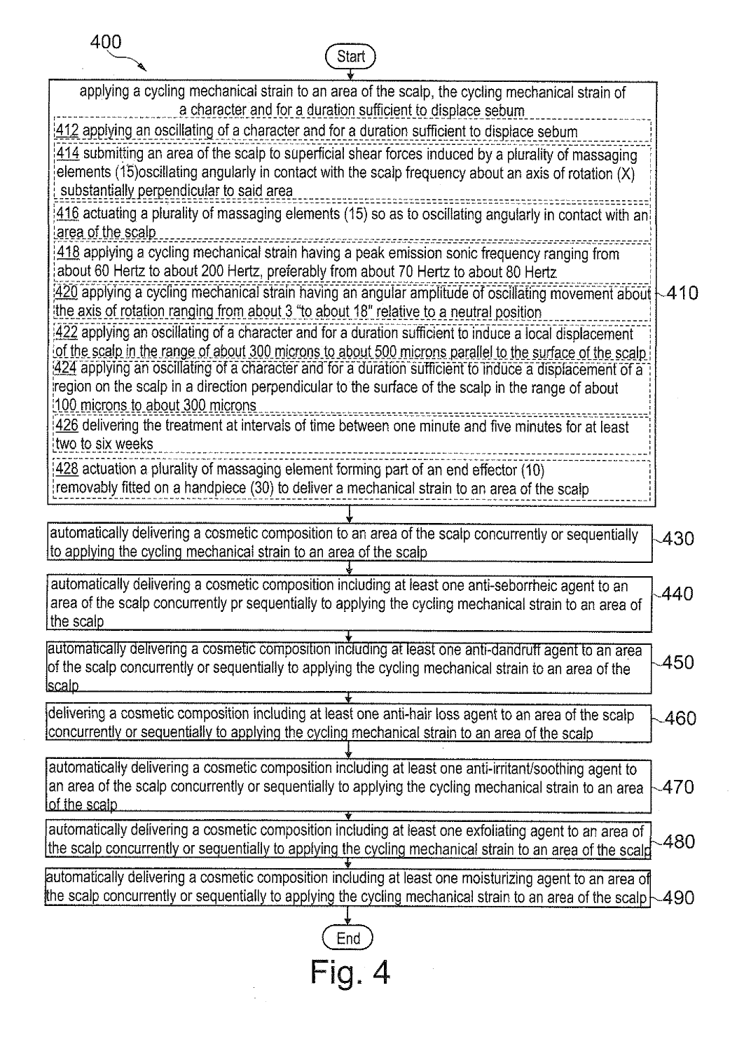

FIG. 4 shows a non-therapeutic cosmetic method 400 for treating a condition associated with sebum production.

At 410, method 400 includes applying a cycling mechanical strain to an area of the scalp, the cycling mechanical strain of a character and for a duration sufficient to displace sebum.

At 412, applying the cycling mechanical strain to an area of ₜhe scalp includes applying an oscillating of a character and for a duration sufficient to displace sebum.

At 414, applying the cycling mechanical strain to an area of the scalp includes submitting an area of the scalp to superficial shear forces induced by a plurality of massaging elements (15) oscillating angularly in contact with the scalp at a sonic frequency about an axis of rotation (X) substantially perpendicular to said area.

At 416, applying the cycling mechanical strain to an area of the scalp includes actuating a plurality of massaging elements (15) so as to oscillating angularly in contact with an area of the scalp.

At 418, applying the cycling mechanical strain to an area of the scalp includes applying a cycling mechanical strain having a peak emission sonic frequency ranging from about 60 Hertz to about 200 Hertz, preferably from about 70 Hertz to about 80 Hertz. In an embodiment, applying the cycling mechanical strain to an area of the scalp includes applying a cycling mechanical strain having a peak emission sonic frequency of about 70 Hz.

At 420, applying the cycling mechanical strain to an area of the scalp includes applying a cycling mechanical strain having an angular amplitude of oscillating movement about the axis of rotation ranging from about 3° to about 18° relative to a neutral position, preferably from about from about 7° to about 11°.

At 422, applying the cycling mechanical strain to an area of the scalp includes applying an oscillating of a character and for a duration sufficient to induce a local displacement of the scalp in the range of about 300 microns to about 500 microns parallel to the surface of the scalp.

At 424, applying the cycling mechanical strain to an area of the scalp includes applying an oscillating of a character and for a duration sufficient to induce a displacement of a region on the scalp in a direction perpendicular to the surface of the scalp in the range of of about 100 microns to about 300 microns.

At 426, applying the cycling mechanical strain to an area of the scalp includes delivering the treatment at intervals of time between one minute and five minutes for at least two to six weeks.

At 428, applying the cycling mechanical strain to an area of the scalp, the cycling mechanical strain of a character and for a duration sufficient to displace sebum includes actuation a plurality of massaging element forming part of an end effector (10) removably fitted on a handpiece (30) to deliver a mechanical strain to an area of the scalp.

At 430, method 400 includes automatically delivering a cosmetic composition to an area of the scalp concurrently or sequentially to applying the cycling mechanical strain to an area of the scalp.

At 440, method 400 includes automatically delivering a cosmetic composition including at least one anti-seborrheic agent to an area of the scalp concurrently or sequentially to applying the cycling mechanical strain to an area of the scalp.

Non-limiting examples of anti-seborrheic agents include compounds that are capable of controlling the activity of the sebaceous glands. Further non-limiting examples of anti-seborrheic agents include retinoic acid; benzoyl peroxide; sulfur; vitamin B6 (or pyridoxine); selenium chloride; sea fennel; mixtures of cinnamon, tea, and octanoylglycine extracts such as Sepicontrol AS TEA® from the supplier Seppic; mixture of cinnamon, sareosine, and octanoylglycine, sold in particular by the supplier SEPPIC under the trade name Sepicontrol A5®; zinc salts such as zinc gluconate, zinc pyrrolidonecarboxylate (or zinc pidolate), zinc lactate, zinc aspartate, zinc carboxylate, zinc salicylate, zinc cysteate; copper derivatives and in particular copper pidolate such as Cuivridone® by Solabia; extracts of plants of the species Arnica montana, Cinchona succirubra, Eugenia caryophyllata, Humulus lupulus, Hypericum perfbratum, Mentha piperita, Rosmarinus officinalis, Salvia officinalis, and Thymus vulgaris, all sold for example by the supplier MARUZEN; extracts of meadowsweet (spiraea ulamaria) such as that sold under the trade name Sebonormine® by the supplier Silab; extracts of Laminaria saccharina (kelp) such as that sold under the trade name Phlorogine® by the supplier Biotechmarine; mixtures of extracts of burnet (Sanguisorba officinalis/Poterium officinale) roots, ginger (Zingiber officinalis) rhizomes, and cinnamon (Cinnamomum cassia) bark such as that sold under the trade name Sebustop® by the supplier Solabia; linseed extracts such as that sold under the trade name Linumine® by the supplier Lucas Meyer; Phellodendron extracts such as those sold under the trade name Phellodendron extract BG by the supplier Maruzen or Oubaku liquid B by the supplier Ichimaru Pharcos; mixtures of argan oil, of Serenoa serrulata (saw palmetto) extract, and of sesame seed extract, such as that sold under the trade name Regu. SEB® by the supplier Pentapharm; mixtures of extracts of willow herb, Terminalia chebula, nasturtium and bioavailable zinc (microalgae) such as that sold under the trade name Seborilys® by the supplier Green tech; extracts of Pygeum afrianum such as that sold under the trade name Pygeum afrianum sterolic lipid extract by the supplier Euromed; extracts of Serenoa serrulata such as those sold under the trade name Viapure Sabal by the supplier Actives International, or those sold by the supplier Euromed; mixtures of extracts of plantain, Berheris aquifolium, and sodium salicylate such as that sold under the trade name Seboclear® by the supplier Rahn; clove extract such as that sold under the trade name Clove extract Powder by the supplier Maruzen; argan oil such as that sold under the trade name Lipofructyl® by Laboratoires Serobiologiques; lactic protein filtrates such as that sold under the trade name Normaseb® by the supplier Sederma; extracts of the alga Laminaria, such as that sold under the trade name Laminarghane® by the supplier Biotechmarine; oligosaccharides of the alga Laminaria digitala such as that sold under the trade name Phycosaccharide AC by the supplier Codif; extracts of cane sugar, such as that sold under the trade name Policasonol® by the supplier Sabinsa; sulfonated schist oil such as that sold under the trade name Iehtyol Pale® by the supplier Ichthyol; meadowsweet (spiraea ulmaria) extracts such as that sold under the trade name Cytobiol® Ulmaire by the supplier Libiol; sebacic acid, in particular sold in the form of a sodium polyacrylate gel under the trade name Sebosoft® by the supplier Sederma; glucomannans extracted from konjac tuber and modified with alkyl sulfonate chains, such as that sold under the trade name Biopol Beta by the supplier Arch Chemical; extracts of Sophora angustifolia, such as those sold under the trade name Sophora powder or Sophora extract by the supplier Bioland; extracts of Cinchona succirubra bark such as that sold under the trade name Red bark HS by the supplier Alban Muller; extracts of Quillaja saponaria such as that sold under the trade name Panama wood. HS by the supplier Alban Muller; glycine grafted onto an undecylenic chain or onto a octanoyl chain, such as that sold under the trade name Lipacide UG OR, Lipacide C8G by the supplier Seppic; oleanolic acid and nordihydroguaiaretic acid mixture such as that sold in the form of a gel under the trade name AC.Net by the supplier Sederma; phthalimidoperoxyhexanoic acid; (C₁₂-C₁₃)trialkyl citrate sold under the trade name COSMACOL® ECI by the supplier Sasol; (C₁₄-C₁₅) trialkyl citrate sold under the trade name COSMACOL® ECL by the supplier Sasol; 10-hydroxydecanoic acid, and in particular mixtures of 10-hydroxydecanoic acid, sebacic acid, and 1,10-decanediol, such as that sold under the trade name Acnacidol® BG by the supplier Vincience; yeast protein hydrolysates such as ASEBIOL LS by COGNIS (mixed with vitamins); and mixtures thereof.

At 450, method 400 includes automatically delivering a cosmetic composition including at least one anti-dandruff agent to an area of the scalp concurrently or sequentially to applying the cycling mechanical strain to an area of the scalp.

Non-limiting examples of anti-dandruff agents include compounds that are capable of preventing the appearance of dandruff, of reducing the amount thereof, and/or of making it disappear completely. Further non-limiting examples of anti-dandruff agents include derivatives of 1-hydroxy-2-pyridone such as 1-hydroxy-4-methyl-2-pyridone, 1-hydroxy-6-methylpyridone, 1-hydroxy-4,6-dimethyl-2-pyridone, 1-hydroxy-4-methyl-6-(2,4,4-trimethylpentyl)-2-pyridone, 1-hydroxy-4-methyl-6-cyclohexyl-2-pyridone, 1-hydroxy-4-methyl-6-(methyl-cyclohexyl)2-pyridone, 1-hydroxy-4-methyl-6-(2-bicyclo [2,2,1]heptyl)-2-pyridone, 1-hydroxy-4-meth yl-6 (4-methylphenyl)-2-pyridone 1-hydroxy-4-methyl-6 [1-[4-nitrophenoxy]-butyl]-2-pyridone, -hydroxy-4-methyl-6-(4-cyanophenoxymethyl-2-pyridone), 1-hydroxy-4-methyl-6-(phenyl sulfonylmethyl)-2-pyridone, 1-hydroxy-4-methyl -6-(4-bromobenzyl)-2-pyridone and salts thereof; By way of preferred derivative of 1-hydroxy-2-pyridone, mention may be made of the composition sold by HOECHST under the trade name octopyrox (1-hydroxy-4-methyl-6-(2,4,4-trimethylpenthyl)-2-pyridone, monoethanolamine salt; pyridinethione salts, in particular calcium, magnesium, barium, strontium, zinc, cadmium, tin, and zirconium salts. Zinc pyridinethione salt is particularly preferred. Zinc pyridinethione salt is sold in particular under the trade name zinc omadine by OLIN; trihalogeno carbamide of formula:

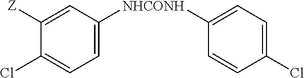

in which Z represents a halogen atom such as chlorine or a C_{I} -C₄ trihalogenoalkyl group such as CF; triclosan represented by the formula:

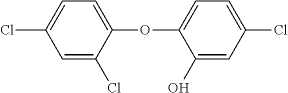 [SMILES: Oc1cc(Cl)ccc1Oc1ccc(Cl)cc1Cl]

azole compounds such as climbazole, ketoconazole, clotrimazole, econazole, isoconazole, and miconazole; anti-fungal polymers such as amphotericin B or nystatin; selenium sulfides, in particular those of formula SₓSe₈₋ₓ, in which x lies in the range 1 to 7; sulfur in its various forms, cadmium sulfide, allantoin, coal or wood tars, and derivatives thereof, in particular juniper tar oil, undecylenic acid, fumaric acid, allylamines such as terbinafine; and ellagic acid.

At 460, method 400 includes automatically delivering a cosmetic composition including at least one anti-hair loss agent to an area of the scalp concurrently or sequentially to applying the cycling mechanical strain to an area of the scalp. Non-limiting examples of anti-hair loss agents include vasodilators such as nicotinic acid esters, including in particular tocopheryl nicotinate, benzyl nicotinate, and C₁-C₆ alkyl nicotinates such as methyl nicotinate or hexyl nicotinate. Further non-limiting examples of anti-hair loss agents include aminexil or Mex (2,4 diamino pyrimidine 3N oxyde); O-acyl derivatives obtained by partial or total esterification of vitamin F by glucose, as described in application EP 1 688 128; and mixtures thereof.

At 470, method 400 includes automatically delivering a cosmetic composition including at least one anti-irritant/soothing agent to an area of the scalp concurrently or sequentially to applying the cycling mechanical strain to an area of the scalp. Non-limiting examples of anti-irritant/soothing agents include anti-inflammatory agents; α-bisabolol; benzydamine; salicylic acid. Further non-limiting examples of anti-irritant/soothing agents include strontium salts; β-glycyrrhetinic acid; glycyrrhizic acid; azulene; essential oils; and extracts of chamomile, oats, aloe vera, verbena, tilia, and licorice.

At 480, method 400 includes automatically delivering a cosmetic composition including at least one exfoliating agent to an area of the scalp concurrently or sequentially to applying the cycling mechanical strain to an area of the scalp. Non-limiting examples of exfoliating agents include abrasive solid particles. Further non-limiting examples of exfoliating agents include abrasive solid particles having a hardness that is greater than or equal to the hardness of the hair. For example, the abrasive solid particles may have a hardness that is greater than or equal to 3 on the Mohs scale, or greater than or equal to 4, e.g. greater than or equal to 5 on the Mohs scale. Further non-limiting examples of exfoliating agents include solid particles selected from natural materials, in particular of mineral or vegetable origin, or from synthetic materials. Further non-limiting examples of exfoliating agents include inorganic and/or metallic particles such as: boron nitride, in body-centered cubic form (Borazon®); aluminosilicate; zircon; mixed oxides of aluminum such as emery; zinc oxide; aluminum oxides such as aluminas or corundum; titanium oxide; titanium oxide coated mica; carbides, in particular silicon carbide (carborundum); or other metal oxides; metals, and metal alloys such as iron shot, steel shot, and in particular perlite; silicates such as glass, quartz, or sand; calcium carbonate (e.g. Bora-Bora sand or Rose de Brignoles sand) or magnesium carbonate; sodium chloride; pumice stone; amorphous silica; diamond; ceramics; organic particles such as: fruit stones, in particular apricot stones, e.g. Scrubami® apricot; wood cellulose, e.g. ground bamboo stem; coconut shell, e.g. coconut exfoliator; polyamides, in particular Nylon-6; sugars; polyethylenes; polypropylenes; and mixed particles associating organic and inorganic compounds, and particles coated in the above compounds.

The solid particles may be of shape that is flat, spherical, elongate, polyhedral, or irregular. By way of example, the solid particles may be derived from pumice stone powder grains, diamond powder, powdered fruit stones, powdered coconut shells, microbeads, e.g. microbeads of alumina, glass, or polyamide, in particular Nylon-6, or fibers, in particular polyamide fibers, or hard fibers of wood cellulose.

At 490, method 400 includes automatically delivering a cosmetic composition including at least one moisturizing agent to an area of the scalp concurrently or sequentially to applying the cycling mechanical strain to an area of the scalp. Non-limiting examples of moisturizing agents include urea; derivatives of urea such as hydroxyethylurea; polyols such as glycerine; propylene glycol; sorbitol; and polyethylene glycols.

In an embodiment, a cosmetic composition includes one or more active agents. For example, in an embodiment, the cosmetic composition includes at least one anti-dandruff agent and at least one anti-seborrheic agent. In an embodiment, a cosmetic composition includes one or more anti-dandruff agents. In an embodiment, a cosmetic composition includes other compounds that are usual in the field of cosmetics for hair such as: vitamins and pro-vitamins, including panthenol; sun screens; colored or colorless inorganic or organic pigments; pearling and opacifying agents; sequestrating agents; plasticizers; solubilizing agents; anti-oxidants; hydroxyacids; fragrances; non-ionic, anionic, cationic or amphoteric surfactants; non-ionic, anionic, cationic, or amphoteric polymers; short-chain alkanols such as ethanol or isopropanol; acidifying agents; alkalinizing agents; non-silicone solid fats; non-silicone oils; silicones; and preservatives.

In an embodiment, a composition is aqueous or anhydrous. In an embodiment, a composition can take any form including powders, liquids, gels, lotions, creams, and non-powder solids. In an embodiment, a composition is sprayed onto the scalp via an aerosol or a pump flask.

### EXAMPLES

The following examples have been carried out in vitro on a human skin treated ex vivo (abdominoplasty) and kept alive for about 10 days.

The massaging is not performed on the human scalp and accordingly a device may be used instead of the device disclosed above. However, this example shows some action of the massaging according to an embodiment on some specific markers.

The massaging is performed with a device gently inducing mechanical strain in the skin at specific frequencies from 0 to 300 Hz and from 0 to 12° of displacement. 2 times per day for 1 minute, during 10 days.

This laboratory device is appropriate to perform a massage on skin according to some features according to an embodiment as this brush performs an oscillating movement about an axis of rotation at a sonic frequency.

Device treatment was applied on skin surface 2 times a day (1 minute) during 10 or 11 days.

The study was conducted twice to confirm the results on two donors.

The massaging was performed at a frequency of 40-60-90-120 and 176 Hz.

Haematoxylin/Eosin/Safran staining (HES) of the all samples are made showing that no morphological changes were observed between the different conditions in both studies, indicating that massage treatment doesn't alter the natural structure of the skin.

Immunolabelling and analysis using an epifluorescence microscope was performed on skin's simples.

### Example 1

### Effect on TGK1 (Transglutaminase 1) and Fillagrin Markers

Terminal differentiation is greatly diminished in persons affected by dandruff problems: the problem of dandruff is to be linked to high sebum production and impaired skin barrier correlated with a decrease in terminal differentiation (GA Turner et al. International Journal of Cosmetic Science, 2012).

Marker

TGK1 (Transglutaminese 1, a catalytic membrane-bound enzyme that functions in the formation of the epidermal cornified cell envelope, which acts as a mechanical barrier to protect against water loss and infectious agents) is to be a marker of terminal differentiation.

Measurement

Measures of TGK1 marker on fluorescence intensity level was performed by immunostaning and quantified by Histolab program, and finally a statistical analysis was performed on the quantification.

The fluorescence intensity (niv.cm²) measures obtained after the massaging skin at 40-60-90-120-176 Hz according to an embodiment have been compared with measures performed in the same conditionson untreated skin on TGK1 marker as comparative test.

The results are as follows: with the massaging according to the invention, the amount of TGK1 marker was more than doubled at 60-90 and 176 Hz compared with the control.

Marker

Fillagrin another protein to be important on the terminal differentiation (involved in the passage of molecules from the stratum granulose to the stratum corneum).

Measures of Filaggrin marker fluorescence intensity level was performed by immunostaning and quantificated by Histolab program, and finally a statistical analysis was performed on the quantification.

The fluorescence intensity (niv.cm²) measures obtained after the massaging skin at 40-60-90-120-176 Hz according to an embodiment have been compared with measures performed in the same conditions on untreated skin on Fillagrin marker as comparative test.

The results are as follows: with the massaging according to the invention, the amount of Filaggrin marker was more than doubled at 40-60 and 1201 Hz compared with the control. A smaller increase was observed at 90 Hz.

These results show that the massaging according to an embodiment helps to fight against dandruff.

### Example 2

### Effect on CD44 Marker

Marker

Alopecia is known to be correlated with a decreased expression of the marker CD44 (hyaluronic acid receptor) in Caucasian men and women in the scalp interfollicular (Pierard - Franchimont and al. 2013).

A massaging on the human skin from plastic surgeries was performed with the laboratory device describes above at 40-60-90-120 and 176 Hz.

Measurement

Measures of CD44 marker on fluorescence intensity level was performed by immunostaning and quantified by Histolab program, and finally a statistical analysis was performed on the quantification.

After 5 or 10 days with the massaging according to the invention, the amount of CD44 marker was doubled with respect to the control at 60-90 and 176 Hz compared with the control (untreated skin)

This evidences that the massaging according to an embodiment helps to diminish hair loss.

1. A non-therapeutic cosmetic method for treating a condition associated with sebum production, comprising:
applying a cycling mechanical strain to an area of the scalp, the cycling mechanical strain of a character and for a duration sufficient to displace sebum.

2. A non-therapeutic cosmetic method for treating a condition associated with sebum production according to claim 1, further comprising:
automatically delivering a cosmetic composition to an area of the scalp concurrently or sequentially to applying the cycling mechanical strain to an area of the scalp.

3. A non-therapeutic cosmetic method for treating a condition associated with sebum production according to claim 1, further comprising:
automatically delivering a cosmetic composition including at least one anti-seborrheic agent to an area of the scalp concurrently or sequentially to applying the cycling mechanical strain to an area of the scalp.

4. A non-therapeutic cosmetic method for treating a condition associated with sebum production according to claim 1, further comprising:
automatically delivering a cosmetic composition including at least one anti-dandruff agent to an area of the scalp concurrently or sequentially to applying the cycling mechanical strain to an area of the scalp.

5. A non-therapeutic cosmetic method for treating a condition associated with sebum production according to claim 1, further comprising:
automatically delivering a cosmetic composition including at least one anti-hair loss agent to an area of the scalp concurrently or sequentially to applying the cycling mechanical strain to an area of the scalp.

6. A non-therapeutic cosmetic method for treating a condition associated with sebum production according to claim 1, further comprising:
automatically delivering a cosmetic composition including at least one anti-irritant/soothing agent to an area of the scalp concurrently or sequentially to applying the cycling mechanical strain to an area of the scalp.

7. A non-therapeutic cosmetic method for treating a condition associated with sebum production according to claim 1, further comprising:
automatically delivering a cosmetic composition including at least one exfoliating agent to an area of the scalp concurrently or sequentially to applying the cycling mechanical strain to an area of the scalp.

8. A non-therapeutic cosmetic method for treating a condition associated with sebum production according to claim 1, further comprising:
automatically delivering a cosmetic composition including at least one moisturizing agent to an area of the scalp concurrently or sequentially to applying the cycling mechanical strain to an area of the scalp.

9. The non-therapeutic cosmetic method for treating a condition associated with sebum production according to claim 1, wherein applying the cycling mechanical strain to an area of the scalp includes applying an oscillating of a character and for a duration sufficient to displace sebum.

10. The non-therapeutic cosmetic method for treating a condition associated with sebum production according to claim 1, wherein applying the cycling mechanical strain to an area of the scalp includes submitting an area of the scalp to superficial shear forces induced by a plurality of massaging elements oscillating angularly in contact with the scalp at a sonic frequency about an axis of rotation (X) perpendicular to said area.

11. The non-therapeutic cosmetic method for treating a condition associated with sebum production according to claim 1, wherein applying the cycling mechanical strain to an area of the scalp includes actuating a plurality of massaging elements so as to oscillating angularly in contact with an area of the scalp.

12. The non-therapeutic cosmetic method for treating a condition associated with sebum production according to claim 1, wherein applying the cycling mechanical strain to an area of the scalp includes applying a cycling mechanical strain having a peak emission sonic frequency ranging from about 60 Hertz to about 200 Hertz.

13. The non-therapeutic cosmetic method for treating a condition associated with sebum production according to claim 1, wherein applying the cycling mechanical strain to an area of the scalp includes applying a cycling mechanical strain having an angular amplitude of oscillating movement about the axis of rotation ranging from about 3° to about 18° relative to a neutral position.

14. The non-therapeutic cosmetic method for treating a condition associated with sebum production according to claim 1, wherein applying the cycling mechanical strain to an area of the scalp includes applying an oscillating of a character and for a duration sufficient to induce a local displacement of the scalp in the range of about 300 microns to about 500 microns parallel to the surface of the scalp.

15. The non-therapeutic cosmetic method for treating a condition associated with sebum production according to claim 1, wherein applying the cycling mechanical strain to an area of the scalp includes applying an oscillating of a character and for a duration sufficient to induce a displacement of a region on the scalp in a direction perpendicular to the surface of the scalp in the range of about 100 microns to about 300 microns.

16. The non-therapeutic cosmetic method for treating a condition associated with sebum production according to claim 1, wherein applying the cycling mechanical strain to an area of the scalp includes delivering the treatment at intervals of time between one minute and five minutes for at least two to six weeks.

17. The non-therapeutic cosmetic method for treating a condition associated with sebum production according to claim 1, wherein applying the cycling mechanical strain to an area of the scalp, the cycling mechanical strain of a character and for a duration sufficient to displace sebum includes actuation a plurality of massaging element forming part of an end effector removably fitted on a handpiece to deliver a mechanical strain to an area of the scalp.

18. A cosmetic massaging device, comprising:
an end effector including
a base part, and
a treating member located centrally with respect to said base part, said treating member having a plurality of massaging elements configured for massaging a scalp, each of the massaging elements having a stem provided at its distal end with an enlarged rounded head; and
a handpiece for oscillating angularly the at least one massaging element at a sonic frequency about a rotation axis.

19. A non-therapeutic cosmetic method for treating a condition associated with sebum production, comprising applying a cycling mechanical strain to an area of the scalp using the cosmetic massaging device as defined in claim 18, the cycling mechanical strain of a character and for a duration sufficient to displace sebum.

20. A kit comprising a device according to claim 18 and a cosmetic composition for applying on the scalp.
